(19) United States
(12) Patent Application Publication
(10) Pub. No.: US 2014/0078908 A1
(43) Pub. Date: Mar. 20, 2014

(54) RESOURCE ALLOCATION APPARATUS IN IP UPLINK

(71) Applicant: Electronics and Telecommunications Research Institute, Daejeon (KR)

(72) Inventor: Jae Heung KIM, Daejeon (KR)

(73) Assignee: Electronics and Telecommunications Research Institute, Daejeon (KR)

(21) Appl. No.: 14/087,769

(22) Filed: Nov. 22, 2013

Related U.S. Application Data
(62) Division of application No. 13/005,258, filed on Jan. 12, 2011.

(30) Foreign Application Priority Data
Jan. 12, 2010 (KR) 10-2010-0002621
Jan. 27, 2010 (KR) 10-2010-0007299
Apr. 14, 2010 (KR) 10-2010-0034272
Apr. 27, 2010 (KR) 10-2010-0038969
Dec. 21, 2010 (KR) 10-2010-0131413

(51) Int. Cl. H04W 72/04; H04W 4/00

(52) U.S. Cl. CPC H04W 72/04; H04W 4/005
USPC 370/242; 370/329

(57) ABSTRACT

Provided is a method that may allocate uplink radio resources to a terminal, and may receive data from the terminal using the radio resources. The uplink radio resources may be allocated as contention-based radio resources in a radio network, such as a cellular system, a radio local access network (LAN), and the like, and thus, a plurality of terminals may effectively transmit data using minimum radio resources.

### CROSS-REFERENCE TO RELATED APPLICATION(S)

This application is a divisional of U.S. patent application Ser. No. 13/005,258, filed on Jan. 12, 2011, which claims the benefit of Korean Patent Application Nos. 10-2010-0002621, 10-2010-0007299, 10-2010-0034272, 10-2010-00038969, 10-2010-131413, respectively filed on Jan. 12, 2010, Jan. 27, 2010, Apr. 14, 2010, Apr. 27, 2010, and Dec. 21, 2010, in the Korean Intellectual Property Office, the disclosures of which are incorporated herein by references.

### BACKGROUND

1. Field of the Invention

The present invention relates to a cellular mobile communication, and more particularly, to a technology that may allocate uplink radio resources to a terminal and may receive data from the terminal based on the radio resources.

2. Description of the Related Art

In a conventional cellular system, radio resources may be allocated to a terminal as dedicated radio resources. In a circuit-based cellular system, when a communication path for exchanging data between a base station and a terminal is connected, regardless of presence or absence of data to be transmitted, a dedicated channel is allocated for data transmission. In a packet-based cellular system, such as, a 3^{rd} generation partnership project (3GPP) long term evolution (LTE) system, when a communication path for exchanging data between a terminal and a base station is connected, uplink radio resources, such as, a transmission frequency carrier and a transmission time, may be allocated, as instantaneous dedicated radio resources, to a terminal, based on a buffer status report reported by the terminal, or a type of set service and thus, the terminal may exclusively transmit a packet.

Various studies have been conducted to improve data transmission efficiency of a mobile communication system and to reduce latency. For example, the uplink radio resources may be allocated, based on a contention-based scheme, to terminals maintaining uplink physical layer synchronization among terminals having a communication path connection, that is, a radio resource control (RRC) connection, to be used for exchanging information, and terminals having information to be transmitted may perform data transmission based on the contention-based scheme and thus, a latency may be reduced.

### SUMMARY

An aspect of the present invention provides a method that may allocate uplink radio resources as contention-based radio resources.

Another aspect of the present invention also provides a method that may perform communication using uplink radio resources with a minimum latency.

According to an aspect of the present invention, there is provided a mobile terminal, a machine-type communication terminal, or a mobile terminal with a machine-type communication function, the terminal including a receiving unit to receive, from a base station, control information with respect to a plurality of contention-based radio resources, a controller to identify the plurality of contention-based radio resources, based on the control information with respect to the plurality of contention-based radio resources, a transmitting unit to transmit, to the base station, data using the plurality of contention-based radio resources.

The transmitting unit may transmit, to the base station, an identifier of the machine-type communication terminal.

The identifier may be one of a cell-radio network temporary identity (C-RNTI) with respect to the machine-type communication terminal, an international mobile subscriber identity (IMSI) with respect to the machine-type communication terminal, a temporary mobile subscriber identity (TMSI) with respect to the machine-type communication terminal, a media access control (MAC) address of the machine-type communication terminal, and a serial number of the machine-type communication terminal.

The controller may identify the plurality of contention-based radio resources, and the transmitting unit may successively transmit the data using the plurality of contention-based radio resources.

The transmitting unit may transmit the data based on a first radio resource among the plurality of contention radio resources, and may complete the transmission of the data when the receiving units receives an acknowledgement (ACK) with respect to the data.

When the receiving unit does not receive the ACK with respect to the data, the transmitting unit may retransmit the data based on a second radio resource among the plurality of contention-based radio resources.

The receiving unit may receive, from the base station, an ACK or a negative acknowledgement (NACK) with respect to the transmitted data.

The receiving unit may receive paging information from the base station, and the transmitting unit may transmit the data in response to the paging information.

The transmitting unit may transmit a resource allocation request to the base station, and the plurality of contention-based radio resources may be allocated in response to the resource allocation request.

According to an aspect of the present invention, there is provided a machine-type communication base station, the base station including a resource allocating unit to allocate the plurality of contention-based radio resources among available radio resources, a transmitting unit to transmit, to a machine-type communication terminal, control information with respect to the plurality of contention-based radio resources, and a receiving unit to receive, from the machine-type communication terminal, data based on the plurality of contention-based radio resources.

The receiving unit may receive an identifier of the machine-type communication terminal.

The resource allocating unit may allocate the plurality of contention-based radio resources, and the receiving unit may complete the reception of the data when the receiving unit receives the data using a first radio resource among the plurality of contention-based radio resources.

When the receiving unit does not receive the data using the first radio resource, the receiving unit may re-receive the data using a second radio resource among the plurality of contention-based radio resources.

The transmitting unit may transmit paging information to the machine-type communication terminal, and the receiving unit may receive the data in response to the paging information.

According to an aspect of the present invention, there is provided a machine-type communication terminal, the terminal including a receiving unit to receive, from a base station, control information with respect to a plurality of contention-based radio resources, and a transmitting unit to transmit, to the base station, using the plurality of contention-based radio resources.

The plurality of contention-based radio resources may include a control area for transmitting a pilot symbol or a preamble, and the data may be demodulated by the pilot symbol or the preamble.

Each of the plurality of contention-based radio resources may include at least one of a time section and a frequency band.

The receiving unit may receive the control information based on system information of the base station.

The plurality of contention-based radio resources may be allocated to several carrier components among a plurality of carrier components.

The contention-based radio resources may be allocated to several components among a plurality of carrier components.

Additional aspects, features, and/or advantages of the invention will be set forth in part in the description which follows and, in part, will be apparent from the description, or may be learned by practice of the invention.

### EFFECT OF THE INVENTION

According to embodiments, uplink radio resources may be allocated based on a contention-based scheme in a cellular system, a wireless local area network (LAN), and the like.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a frame according to an embodiment of the present invention;

FIG. 2 is a diagram illustrating a subframe according to an embodiment of the present invention;

FIG. 3 is a diagram illustrating a case where a plurality of carrier frequencies is used;

FIG. 4 is a flowchart illustrating a process that allocates uplink radio resources based on a contention-based scheme;

FIG. 5 is a flowchart illustrating a process that allocates uplink radio resources based on a request for resources;

FIG. 6 is a flowchart illustrating a process that allocates uplink radio resources based on paging information;

FIG. 7 is a diagram illustrating an example that transmits an acknowledgement (ACK) or negative acknowledgement (NACK) in response to data transmission;

FIG. 8 is a diagram illustrating an example of a scheduling message according to an embodiment of the present invention;

FIG. 9 is a block diagram illustrating a machine-type communication terminal according to an embodiment of the present invention;

FIG. 10 is a block diagram illustrating a machine-type communication base station according to another embodiment of the present invention; and

FIG. 11 is a block diagram illustrating a machine-type communication terminal according to another embodiment of the present invention.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

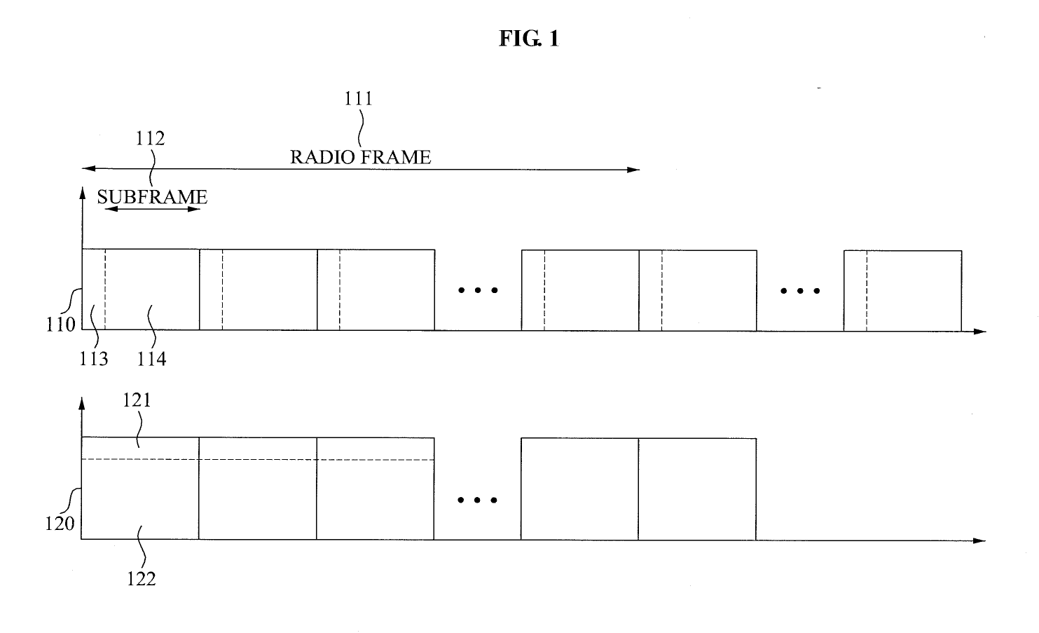

FIG. 1 illustrates a frame according to an embodiment of the present invention.

An example that distinguishes a downlink 110 and an uplink 120 based on a frequency division duplex (FDD) scheme is illustrated in FIG. 1. Even though only the FDD scheme is described in FIG. 1, another embodiment of the present invention may be further applicable to a radio transmission system based on a time division duplex (TDD) scheme.

A horizontal axis may denote a time, and a vertical axis may denote a frequency. In the downlink 110, a control information area 113 and a data area 114 may be multiplexed over time, and in the uplink 120, a control information area 121 and a data area 122 may be multiplexed based on a frequency. Depending on embodiments, the control information area 113, the data area 124, the control information area 121, and the data area 122 may be multiplexed over time or frequency, regardless of an uplink and a downlink.

A single radio frame 111 of the downlink 110 may include a plurality of subframes. A single subframe 112 may include the control information area 113 and the data area 114, and may denote a scheduling period, that is, a fundamental period for resource allocation. A single subframe of the uplink 120 may include the control information area 121 and the data area 122.

When the data area 122 of the subframe included in the uplink 120 is used for contention-based data transmission, the control information area 113 of the downlink 110 may include radio resource allocation information with respect to the data area 122.

In an aspect of embodiments, machine-type communication terminals may receive, using the data area 112 of the downlink 110, data from a machine-type communication base station, and may transmit, using the control information area 121 or the data area 122, acknowledgements (ACKs) or negative acknowledgements (NACKs) with respect to the received data. Depending on embodiments, the machine-type communication terminals may transmit, to the machine-type communication base station, the ACKs or the NACKs with respect to the received data, via a separate control channel.

When the data area 122 of the uplink 120 is allocated as contention-based resources, resource allocation information with respect to the data area 122 may be transmitted using the control information area 113 of the downlink 110, and may also be transmitted using system information transmitted, by a base station, for machine-type communication, or using separate resource allocation information, for example, a paging procedure and a scheme using a message.

The control information area 121 of the uplink 120 may be allocated, as dedicated resources, to a machine-type communication terminal that maintains a communication path connection for exchanging information with the machine-type communication base station, and may be operated. In this example, the machine-type communication terminals that transmit data, based on the contention-based resources, may transmit unique control information using the control information area 121 of the uplink 120.

In addition to the contention-based data transmission, the data may be transmitted by sharing radio resources. A plurality of machine-type communication terminals may share uplink radio resources and may share the radio resources without contention to transmit the data. When the plurality of machine-type communication terminals transmit the data by sharing the radio resources without contention, the radio resources may be referred to as shared allocation radio resources. Unlike the contention-based data transmission, in sharing-based data transmission, a terminal group or an MTC device group may share contention-based uplink radio resources and may share the uplink radio resources without contention for a time or a sub-carrier area.

Several machine-type communication terminals may have a significantly low data occurrence frequency and thus, may mostly perform monitoring or sensing. The machine-type communication terminals may periodically or aperiodically transmit data based on a control by the machine-type communication base station. In this example, each of the machine-type communication terminals may control resource allocation to share radio resources between the machine-type communication terminals and thus, the machine-type communication terminals may prevent collision due to contention between the machine-type communication terminals.

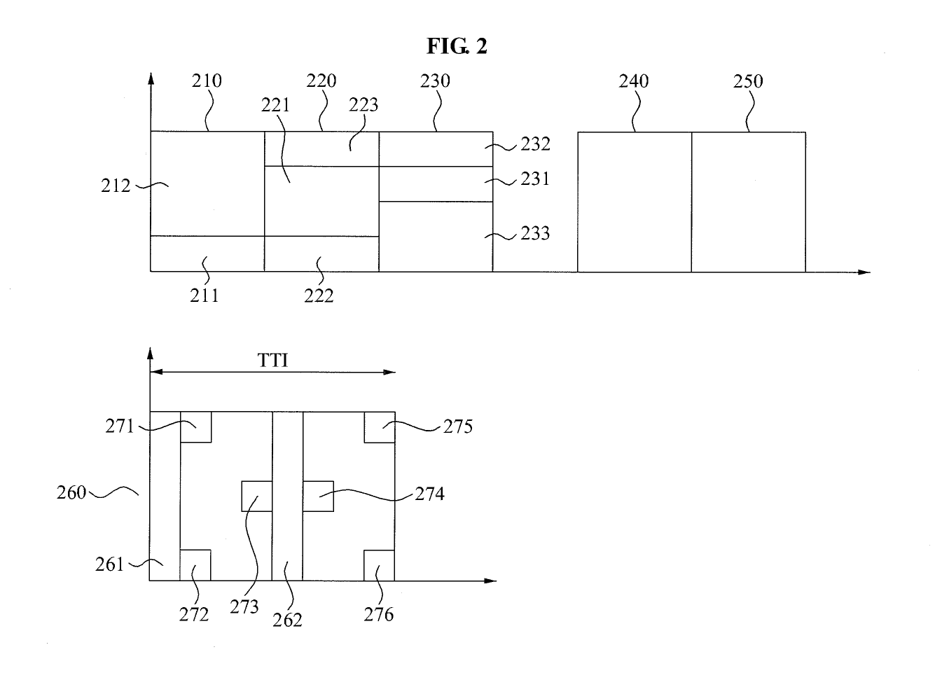

FIG. 2 illustrates a subframe according to an embodiment of the present invention.

A horizontal axis may denote a time and a vertical axis may denote a frequency band. The vertical axis may denote indices of sub-carriers.

In a first sub-frame 210, a predetermined sub-carrier area 211 may be allocated as contention-based radio resources or the shared allocation radio resources, and sub-carrier area 212 may be allocated as normal dedicated radio resource.

In a second subframe 220, sub-carrier areas 222 and 223, which are separated from each other, may be allocated as the contention-based radio resources or the shared allocation radio resources, and the sub-carrier area 221 may be allocated as the dedicated radio resources.

In a third subframe 230, a sub-carrier band 231 located in a middle of the subframe 230 may be allocated as the contention-based radio resources or the shared allocation radio resources, and sub-carrier bands 232 and 233 may be allocated as the dedicated radio resources.

In a fourth subframe 240, all uplink areas of a single subframe may be allocated as the contention-based radio resources or the shared allocation radio resources, and in a fifth subframe 250, the all uplink areas of the single subframe may be allocated as the dedicated radio resources.

In the example embodiment, only radio resources for data transmission are described. A control information area may be allocated to a predetermined area of an uplink subframe separately from a data area, or may be allocated by puncturing a portion of the data area.

The control information area may relieve uplink interference in an orthogonal frequency division multiplexing (access) (OFDM (A))-based radio communication system, and may include pilot symbols 271, 272, 273, 274, 275, 276 or preambles 261 and 262 to obtain an orthogonality between uplink sub-carriers.

In an aspect of embodiments, the preambles 261 and 262 or the pilot symbols 271, 272, 273, 274, 275, and 276 may include different patterns based on a machine-type communication terminal, a terminal group including the machine-type communication terminal, or a property of a service used by the machine-type communication terminal.

A machine-type communication base station may allocate the contention-based radio resources, based on the machine-type communication terminal, the terminal group including the machine-type communication terminal, or the property of a service used by the machine-type communication terminal.

In an aspect of embodiments, the machine-type communication base station may transmit, to the machine-type communication terminal based on system information, a group composition of each property, mapping relation of contention-based radio resources with respect to each group, or radio resource allocation information. The machine-type communication terminal may receive radio resource allocation information based on a property, and may recognize the contention-based radio resources. The system information may include the radio resource allocation information, modulating and coding information, radio resource access information, and the like.

In an aspect of embodiments, the terminal group may include a plurality of machine-type communication terminals. The machine-type communication terminals included in the same terminal group may share contention-based radio resources allocated to the terminal group, and may transmit data using the corresponding radio resources based on a contention scheme.

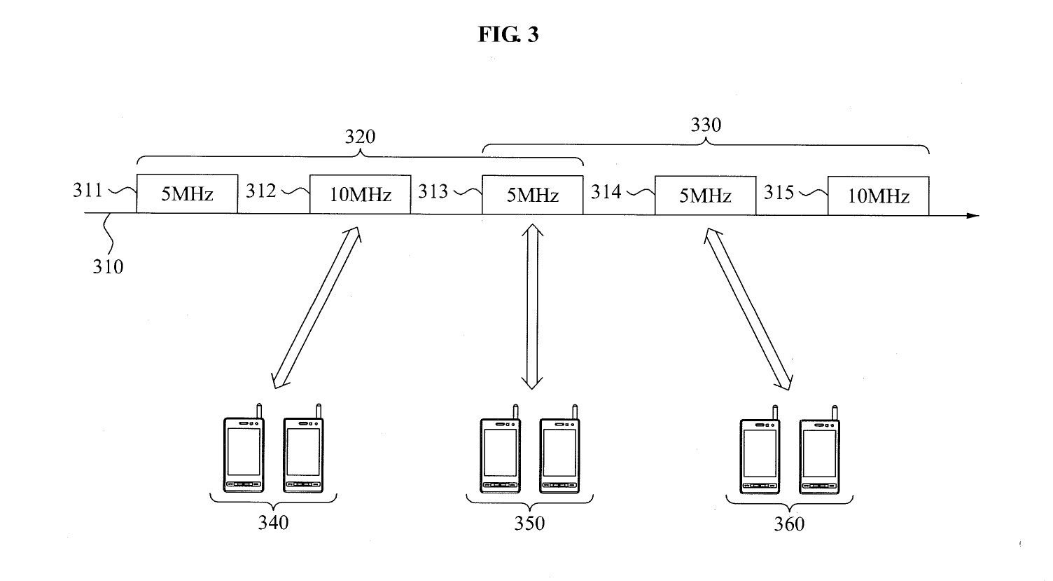

FIG. 3 illustrates a case where a plurality of carrier frequencies is used.

Referring to FIG. 3, a first machine-type communication base station may receive, using frequency bands 311, 312, and 313, data from machine-type communication terminals 340 and 350. A second machine-type communication base station may receive, using frequency bands 313, 314, and 315, data from machine-type communication terminals 350 and 360.

In an aspect of embodiments, a first terminal group 340 may transmit data by receiving, from the first machine-type communication base station, uplink radio resources scheduled as dedicated radio resources. A second terminal group 350 may transmit data, using a frequency band 313, that both the first machine-type communication base station and the second machine-type communication base station allocate as contention-based radio resources or shared allocation radio resources. A third terminal group 360 may transmit data by receiving, from the second machine-type communication base station, uplink radio resources scheduled as dedicated radio resources.

Even through a case where a plurality of machine-type communication base stations allocate the same frequency band as the contention-based frequency band or the shared allocation frequency band is described in FIG. 3, the plurality of machine-type communication base stations may allocate different frequency bands as the contention-based frequency band or the shared allocation frequency band, depending on embodiments.

In an aspect of embodiments, a machine-type communication base station may use a plurality of component carriers based on carrier aggregation, and may allocate, based on a component carrier unit, a frequency band as a contention-based frequency band or a shared allocation frequency band.

In another aspect of embodiments, the machine-type communication base station may utilize a sub-carrier band included in a component carrier as the contention-based frequency band or the shared allocation frequency band.

In an aspect of embodiments, the contention-based frequency band or shared allocation frequency band may be allocated based on a capability of the machine-type communication terminal. Downlink control information, system information, and the like may command the machine-type communication terminal to perform information transmission based on the contention-based radio resources or the shared allocation radio resources. The downlink control information or the system information may include contention-based resource allocation information or shared allocation resource allocation information. The downlink control information, the system information, and the like may be pre-configured or may be determined based on an activation process or a deactivation process. Physical layer information for data transmission may be determined. The physical layer information may include modulating and coding information, pattern information associated with a contention-based preamble or pilot symbol or pattern information associated with a shared allocation preamble or pilot symbol, transmission power information associated with the machine-type communication terminal, and the like.

In an aspect of embodiments, the machine-type communication base station may allocate desired uplink radio resources based on a dedicated allocation scheme that uses a scheduling identifier with respect to each machine-type communication terminal, and the scheduling identifier may be an identifier used for allocating resources to a terminal or terminals in a base station. The machine-type communication base station may allocate the uplink radio resources based on a scheduling identifier corresponding to a service that each terminal group or each machine-type communication terminal uses.

In an aspect of embodiments, the machine-type communication base station may differently utilize the contention-based radio resources or shared allocation radio resources based on a property of a machine-type communication terminal. For example, the machine-type communication base station may determine a type of transmittable information, a minimum transmission unit, a modulation and coding level, an available contention-based radio resource area or shared allocation radio resource area, whether to perform retransmission, a transmission power, a resource allocation period and frequency, and the like, based on a service that the machine-type communication terminal uses, a terminal group including the machine-type communication terminal, and the like, and the machine-type communication base station may provide a service based on the determination.

The type of the transmittable information may include following:
1) a type of control message that is not transmittable
2) a type of traffic information that is not transmittable

The minimum transmission unit may include following:.
1) a magnitude of resource allocation
2) a size of a maximum transmittable message
3) a size of a maximum transmittable coded block

The modulation and coding level may include following:
1) a modulation scheme, for example, QPSK, 8PSK, and QAM
2) a coding level (a coding scheme and a coding level) In an aspect of embodiments, a predetermined machine-type communication device may not allow a packet loss due to collision led by a contention scheme. In this example, the machine-type communication base station may allocate desired uplink radio resources based on a shared allocation scheme or based on a dedicated allocation scheme that uses, in a general cellular system, a scheduling identifier, for example, a cell-radio network temporary identity (C-RNTI) in the 3GPP LTE system and the like.

The machine-type communication base station may use a different scheduling identifier for each of the machine-type communication terminal, a service that the machine-type communication terminal uses, and a terminal group including the machine-type communication terminal, and may allocate contention-based uplink radio resources or shared allocation uplink radio resources based on the different scheduling identifiers.

The machine-type communication base station may apply the different scheduling identifier for each of the machine type communication terminal, the terminal group including a machine-type communication device, and the like. The machine-type communication base station may allocate different scheduling identifiers based on whether a communication path, for example, an RRC connection of the 3GPP system, between the machine-type communication base station and the machine-type communication terminal is connected, or based on whether uplink synchronization is maintained and set.

In an aspect of embodiments, the machine-type communication base station may differently apply a contention-based uplink radio resource allocation scheme or a shared allocation uplink radio resource allocation scheme, based on whether the machine-type communication terminal maintains an uplink physical layer transmission synchronization or whether the machine-type communication terminal obtains the uplink physical layer transmission synchronization. The machine-type communication base station may differently apply a transmission scheme of the machine-type communication terminal, based on whether the machine-type communication terminal maintains the uplink physical layer transmission synchronization or whether the machine-type communication terminal obtains the uplink physical layer transmission synchronization.

For example, the machine-type communication base station may use uplink radio resources by distinguishing uplink radio resources to be allocated to a machine-type communication terminal that maintains the uplink synchronization from uplink radio resources to be allocated to a machine-type communication terminal that does not maintain the uplink synchronization.

When the machine-type communication terminal that maintains the uplink synchronization performs transmission based on the contention-based uplink radio resources or the shared allocation uplink radio resources, the machine-type communication base station may use uplink radio resources to enable the machine-type communication terminal to perform data transmission without using a separate contention-based transmission preamble or a separate contention-based transmission pilot symbol.

When a terminal or the machine-type communication terminal that does not maintain the uplink synchronization performs transmission based on the contention-based uplink radio resources or the shared allocation uplink radio resources, the machine-type communication base station may use uplink radio resources to enable the terminal or the machine-type communication terminal to perform data transmission using the separate contention-based transmission preamble or the separate contention-based transmission pilot symbol.

The machine-type communication base station may allocate, with a minimum latency, the contention-based uplink radio resources or shared allocation uplink radio resources, regardless of whether a communication path between a machine-type communication terminal and the machine-type communication base station is connected or whether the uplink synchronization is maintained or set, and may receive data using the allocated radio resources.

The machine-type communication base station may allocate, to the terminal group in advance, the contention-based uplink radio resources or the shared allocation uplink radio resources and thus, the machine-type communication base station may receive, with a minimum latency, data without a separate request for uplink radio resources from the machine-type communication terminal.

The machine-type communication base station may allocate uplink radio resources based on control information, for example, system information block (SIB) information of the 3GPP system, that an edge node in a radio network, for example, a base station, informs a corresponding service area in common, as opposed to using the scheduling identifier.

In this example, the machine-type communication base station may allocate different contention-based radio resources or different shared allocation radio resources to machine-type communication terminals, based on whether the communication path between the machine-type communication base station and the machine-type communication terminal is connected or whether the uplink synchronization is maintained and set.

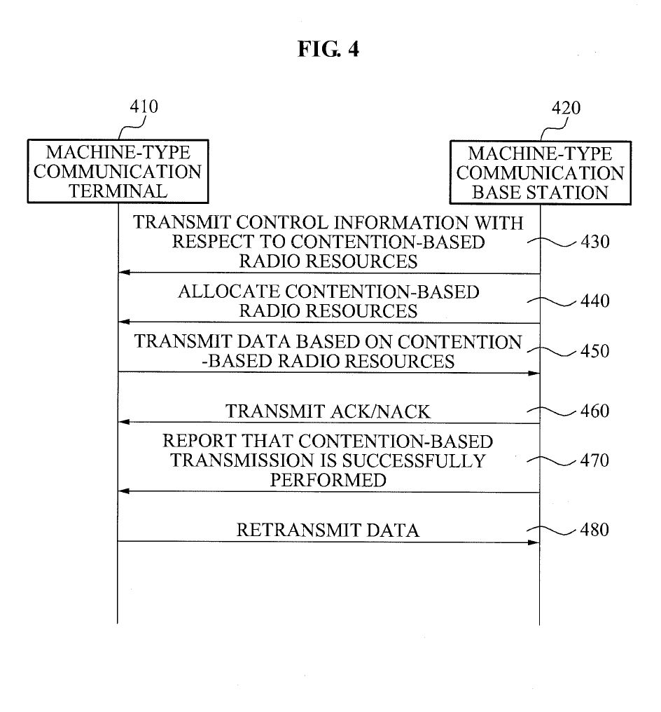

FIG. 4 illustrates a process that allocates uplink radio resources based on a contention-based scheme.

In operation 430, a machine-type communication base station 420 may transmit control information with respect to contention-based radio resources to a plurality of machine-type communication terminals in a coverage, for example, a machine-type communication terminal 410. In an aspect of embodiments, the machine-type communication base station 420 may broadcast, based on system information, the control information with respect to the contention-based radio resources to the plurality of machine-type communication terminals in the coverage. In another aspect of embodiments, the machine-type communication base station 420 may transmit, using a separate control channel, the control information with respect to the contention-based radio resources to the plurality of machine-type communication terminals.

Depending on embodiments, the machine-type communication base station 420 may transmit control information with respect to shared allocation radio resources to the plurality of machine-type communication terminals in the coverage in operation 430.

In operation 440, the machine-type communication base station 420 may allocate the contention-based radio resources to the plurality of machine-type communication terminals. The machine-type communication terminals may identify the contention-based radio resources based on the control information with respect to the contention-based radio resources.

Depending on embodiments, the machine-type communication base station 420 may allocate the shared allocation radio resources to the plurality of machine-type communication terminals in operation 440. The machine-type communication terminals may identify the shared allocation radio resources based on the control information with respect to the shared allocation radio resources.

In operation 440, the machine-type communication base station 420 may transmit an identifier, of the machine-type communication terminal 410 that will transmit data based on corresponding radio resources, to the machine-type communication terminals in the coverage. The machine-type communication terminal 410 may compare its own identifier with the received identifier, and may identify radio resources to be used when the machine-type communication terminal 410 performs the data transmission.

In an aspect of embodiments, the machine-type communication base station 420 may transmit, to the plurality of machine-type communication terminals in the coverage, the identifier of the machine-type communication terminal 410, an identifier of a terminal group including the machine-type communication terminal 410, or an identifier corresponding to a service that the machine-type communication terminal 410 uses, and the machine type communication terminal 410 may identify radio resources to be used for the data transmission by comparing its own identifier with the received identifier.

In operation 450, the machine-type communication base station 420 may receive data from the machine-type communication terminal 410, based on the contention-based radio resources or the shared allocation radio resources.

In an aspect of embodiments, the machine-type communication base station 420 may receive data from the machine-type communication terminal 410, based on contention-based radio resources. The contention-based radio resources may be radio resources used by a plurality of machine-type communication terminals for data transmission without communication. When only one machine-type communication terminal transmits data based on a predetermined radio resource, the machine-type communication base station 420 may successfully receive the data. However, when the plurality of machine-type communication terminals transmits data based on the same radio resource, the machine type communication base station 420 may not successfully receive the data. Therefore, data transmission using the contention-based radio resources may have a high probability of error.

In another aspect of embodiments, the machine-type communication base station 420 may receive data from the machine type communication terminal 410, based on the shared allocation radio resources. The shared allocation radio resources may be radio resources allocated to a terminal group including a plurality of machine-type communication terminals. The plurality of machine-type communication terminals may communicate to select a machine-type communication terminal, for example, the machine-type communication terminal, to transmit data using a predetermined radio resource. Therefore, the data transmission using the shared allocation radio resources may have a significantly low probability of error.

In an aspect of embodiments, the machine-type communication base station 420 may allocate a plurality of radio resources as the contention-based radio resources or the shared allocation radio resources in operation 440. For example, a shared allocation radio resource may be successively allocated or a plurality of radio resources may be discretely allocated over multiple subframes. In this example, the machine-type communication base station 420 may repeatedly receive the same data from the machine-type communication terminal 410 using the plurality of radio resources in operation 450. When the same data is repeatedly received, a probability of error may decrease and thus, a reliability of the data transmission may increase.

According to an embodiment, the machine-type communication base station 420 may determine whether the received data has an error, and transmit, to the machine-type communication terminal 410, an ACK or an NACK with respect to the received data in operation 460.

Depending on embodiments, the machine-type communication base station 420 may successfully receive the data in operation 450. In this example, the machine-type communication base station 420 may transmit the identifier of the machine-type communication terminal 410 that transmits the data, to the corresponding machine-type communication terminal 410.

Based on a set of a system, the machine-type communication base station 420 may perform one of operation 450 and operation 460.

When the data transmission fails in operation 450, the machine-type communication terminal 410 may receive an NACK from the machine-type communication base station 420. In this example, the machine-type communication terminal 410 may retransmit the corresponding data in operation 480.

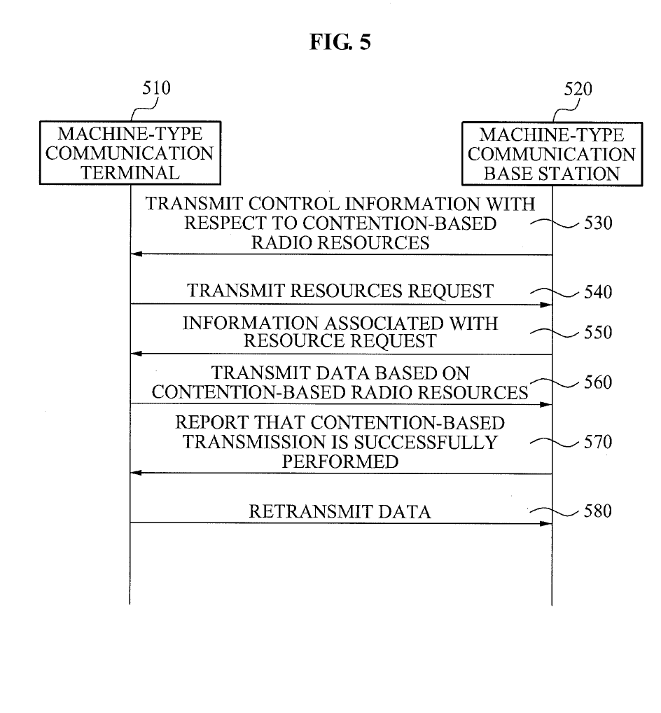

FIG. 5 illustrates a process that allocates uplink radio resources based on a request for resources.

In operation 530, a machine-type communication base station 520 may transmit control information with respect to contention-based radio resources or shared allocation radio resources, to the machine-type communication terminal 510. According to an embodiment, the machine-type communication base station 520 may transmit, based on system information of the machine-type communication base station 520, the control information with respect to the contention-based radio resources or the shared allocation radio resources.

In operation 540, the machine-type communication terminal 510 may transmit a request for resources to the machine-type communication base station 520. In this example, a procedure that requests the resources may use a resource request procedure set by a system or may use a random access procedure. A plurality of machine-type communication terminals may share and use resource request bit information, for example, scheduling request (SR) bit information included in uplink control information, to be used for requesting resources, or an access preamble to be used for requesting the resources.

The machine-type communication base station 520 may distinguish a portion of the random access preamble and may allocate the distinguished portion of the random access preamble as a preamble for contention-based transmission. The machine-type communication base station 520 may transmit, to the machine-type communication terminal 510, information associated with the preamble for the contention-based transmission as control information.

In operation 550, the machine-type communication terminal 510 may identify the contention-based radio resources or the shared allocation radio resources based on the control information received from the machine-type communication base station 520.

Operations 560 through 580 are similar to operations 450 through 480 of FIG. 4 and thus, detailed descriptions thereof will be omitted.

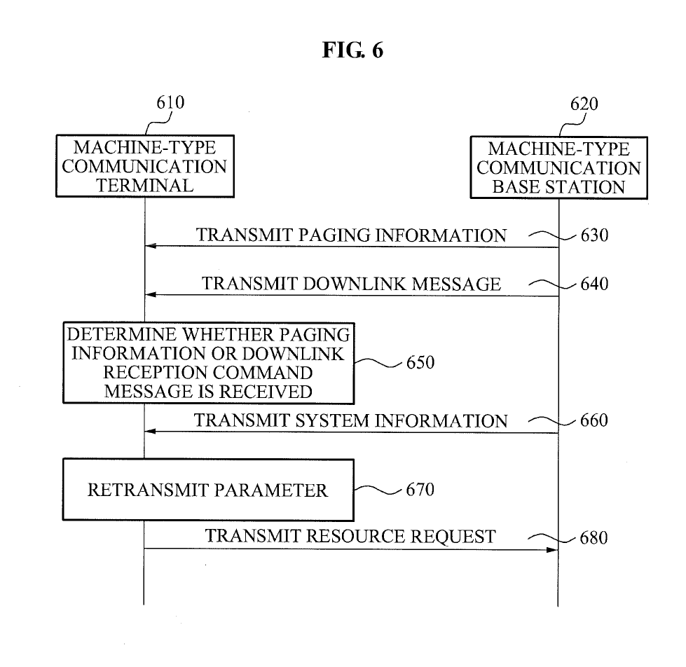

FIG. 6 illustrates a process that allocates uplink radio resources based on paging information. According to an embodiment, a machine-type communication base station 620 may transmit, using paging information, random command information to a downlink. The machine-type communication base station 620 may control an operation of the machine-type communication terminal 610, based on the paging information.

For example, the machine-type communication base station 620 may allocate a scheduling identifier to the machine-type communication terminal 610, or may allocate a scheduling identifier to a terminal group including the machine-type communication terminal 610. The machine-type communication base station 620 may transmit downlink command information based on the scheduling identifier.

In an aspect of embodiments, the downlink command information may include following:
1) a command to receive system information
2) a command to machine-type communication terminals to receive control information
3) a command to reset a parameter associated with a service used by a machine-type communication terminal
4) a command to report uplink or to transmit a message
5) a command to receive SW upgrade for a service or a machine-type communication terminal

In operation 630, the machine-type communication base station 620 may transmit the paging information or a downlink reception command message based on the scheduling identifier allocated to the machine-type communication terminal 610. In this example, a C-RNTI that is temporarily set by the machine-type communication base station 620 to identify the machine-type communication terminal 610 and the like may be used as the scheduling identifier.

In operation 640, the machine-type communication base station 620 may transmit a downlink message corresponding to the paging information or the downlink reception command message. The machine-type communication terminal 610 may receive the downlink message, based on the paging information or the downlink reception command message.

According to an embodiment, the machine-type communication base station 620 may allocate a separate radio resource to transmit the paging information or the downlink message, and the machine type communication terminal 610 may transmit, using the paging information or the downlink reception command message, information associated with the radio resource that transmits the downlink message.

In operation 650, the machine-type communication terminal 610 may check the reception of the paging information or the downlink reception command message, and may perform, based on the received paging information or the downlink reception command message, requesting uplink resources, resetting a parameter, receiving SW upgrade for a machine-type communication function, and the like.

In operation 660, the machine-type communication terminal 610 may receive system information from the machine-type communication base station 620. In an aspect of embodiments, the machine-type communication terminal 610 may reset the parameter based on a parameter included in the system information in operation 670.

In operation 680, the machine-type communication terminal 610 may transmit, to the machine-type communication base station 620, a resource request requesting uplink radio resources to be used for data transmission. In an aspect of embodiments, uplink radio resources to be used for transmitting the resource request to the machine-type communication base station 620 may have a predetermined mapping relation with the scheduling identifier or the radio resource of the downlink message and the like. In this example, even though control information with respect to the uplink radio resource to be used for transmitting the resource request is not explicitly received, the machine-type communication terminal 610 may transmit the resource request.

In this example, the predetermined mapping relation may denote mapping relations with a frequency band of radio resources used for transmitting the resource request and the downlink message, a carrier component, an index of a subframe that transmits the resource request, transmission timing information, modulating and coding information, and the like. When the resource request is transmitted based on the random access procedure, the predetermined mapping relation may include a relation with an index of the random access preamble, and with the downlink message.

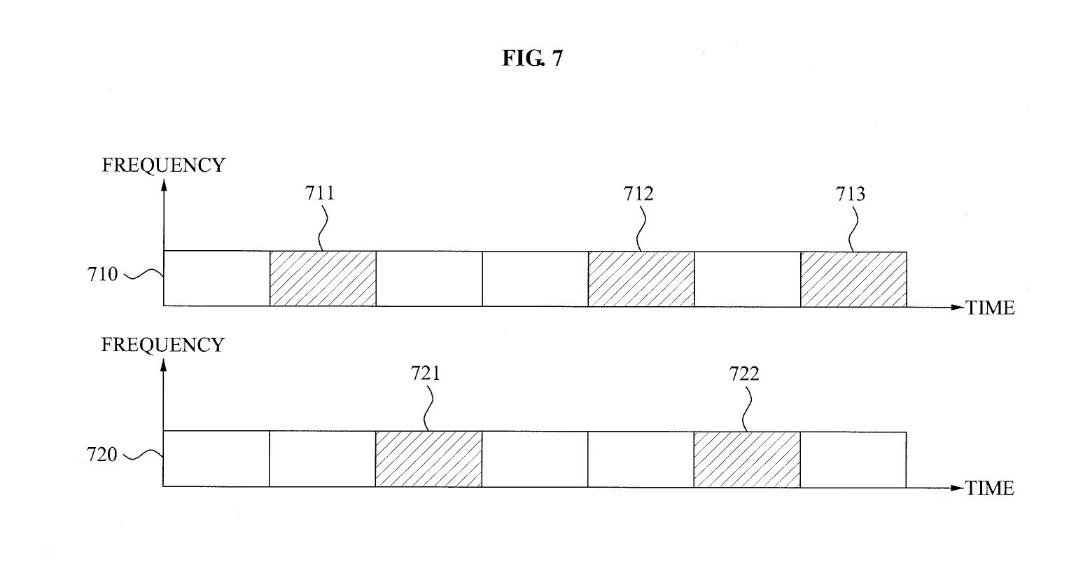

FIG. 7 illustrates an example that transmits an ACK or a NACK in response to data transmission.

A machine-type communication base station may allocate a plurality of uplink radio resources to a machine-type communication terminal, and may transmit control information with respect to the plurality of allocated radio resources, using a single piece of scheduling information. The machine-type communication terminal may receive, using the scheduling information, the control information with respect to the plurality of radio resources. The machine-type communication terminal may identify the plurality of allocated radio resources based on the control information.

Referring to FIG. 7, the machine-type communication base station may allocate a plurality of radio resources of an uplink 710, for example, a first uplink radio resource 711, a second uplink radio resource 712, and a third uplink radio resource 713, for uplink data transmission. The machine-type communication terminal may transmit data, using the uplink radio resources as contention-based radio resources or shared allocation based resources.

When the machine-type communication terminal transmits data based on the contention-based radio resources, the uplink radio resources, for example, the first uplink radio resource 711, the second uplink radio resource 712, and the third uplink radio resource 713, may be allocated to a terminal group including a plurality of machine-type communication terminals. The machine-type communication terminals may select at least one radio resource from the allocated uplink radio resources, and may transmit data based on the selected at least one uplink radio resource.

A first machine-type communication terminal included in the terminal group may select the first uplink radio resource 711. When another machine-type communication terminal included in the terminal group does not select the first uplink radio resource 711, the first machine-type communication terminal may successfully transmit the data using the first uplink radio resource 711. In this example, the first machine-type communication terminal may receive, using a first downlink radio resource 721, an ACK with respect to the transmitted data. The first machine-type communication terminal completes the data transmission, the first machine-type communication terminal may not use the second uplink radio resource 712 and the third uplink radio resource 713. The machine-type communication base station may allocate the second uplink radio resource 712 and the third uplink radio resource 713 to another terminal group and thus, may additionally receive data. When a NACK with respect to the transmitted data is received using the first downlink radio resource 721, retransmission may be performed using the second uplink radio resource 712. When an ACK with respect to the second uplink radio resource 712 is received using the second downlink radio resource 722, the third uplink radio resource may not be used.

In an aspect of embodiments, not only the first machine-type communication terminal but also a second machine-type communication terminal included in the same terminal group may select the first uplink radio resource 711. In this example, both the first machine-type communication terminal and the second machine-type communication terminal may perform data transmission using the first uplink radio resource 711. Two pieces of data may collide with each other and thus, the machine-type communication base station may not receive the data and may not transmit an ACK using the first downlink radio resource 721.

In this example, the first machine-type communication terminal and the second machine-type communication terminal may select at least one radio resource from the second uplink radio resource 712 and the third uplink radio resource 713, and may retransmit data using the selected at least one radio resource. When the first machine-type communication terminal and the second machine-type communication terminal select different radio resources, data transmission may have a high probability of being successfully performed. When the first machine-type communication terminal selects the second uplink radio resource 712 to retransmit the data, and the retransmission is successfully performed, the first machine-type communication terminal may receive an ACK with respect to the retransmitted data using the second downlink radio resource 722.

Depending on embodiments, the first machine-type communication terminal and the second machine-type communication terminal included in the terminal group may perform data transmission based on the shared allocation radio resources. In this example, the first machine-type communication terminal and the second machine-type communication terminal included in the same terminal group may communicate to determine a radio resource to be used by each of the first machine-type communication terminal and the second machine-type communication terminal. In an aspect of embodiments, the first machine-type communication terminal and the second machine-type communication terminal determine that the first machine-type communication terminal transmits first data using the first uplink radio resource 711 and the second machine-type communication terminal transmits second data using the second uplink radio resource 712. In this example, the data transmission may have a high probability of being successfully performed.

Referring to FIG. 7, the machine-type communication base station may allocate, to the terminal group, the plurality of radio resources through a single radio resource allocation procedure. The machine-type communication terminal included in the terminal group may transmit data using a single radio resource among the allocated radio resources, and, when the data transmission fails, may retransmit the data using another radio resource among the allocated radio resources.

Referring to FIG. 7, when the data transmission fails, data allocation may not be performed again. Therefore, the machine-type communication terminal may successfully transmit data through a simple procedure.

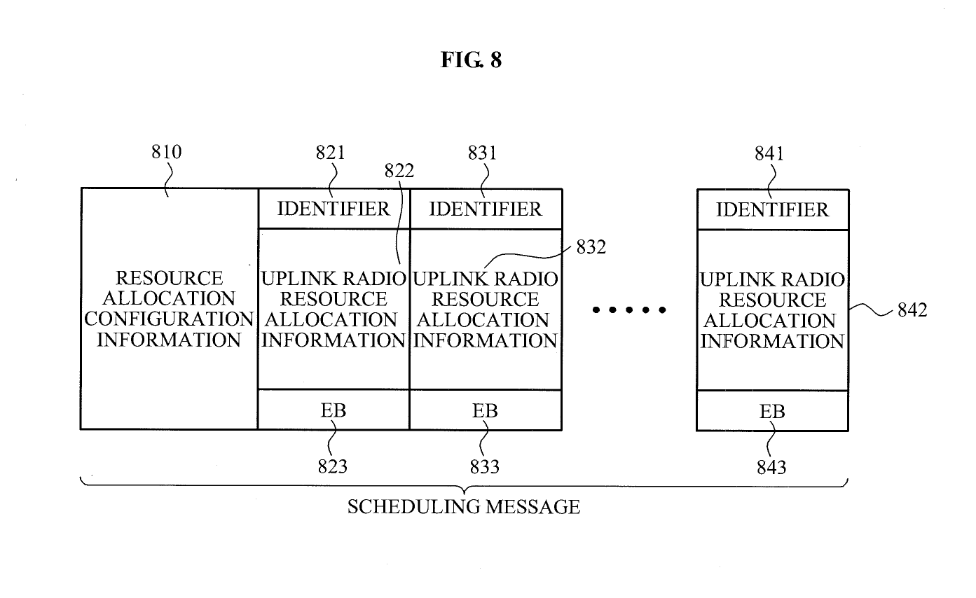

FIG. 8 illustrates an example of a scheduling message according to an embodiment of the present invention.

The scheduling message may be used for transmitting, from the machine-type communication base station to the machine-type communication terminal, information associated with uplink radio resources allocated to the machine-type communication terminal.

In an aspect of embodiments, the scheduling message may include allocation information IE and resource allocation configuration information IE 810. IE stands for information element. In this example, the resource allocation configuration information IE 810 may include a size of the scheduling message, a number of allocation information IEs included in the scheduling message, and a size of allocation information IE. A single piece of the allocation information IE may include an identifier of the machine-type communication terminal, for example, an identifier 821, an identifier 831, and an identifier 841, uplink radio resource allocation information, for example, uplink radio resource allocation information 821, uplink radio resource allocation information 831, and uplink radio resource allocation information 841, and an extension bit (EB), for example, an IE 823, an IE 833, and an IE 843.

The identifier may be information indicating a corresponding machine-type communication terminal for allocation information IE, and may include information associated with an identifier of the corresponding terminal. In this example, an identifier, for example, an C-RNTI, that the machine-type communication base station temporarily allocates to identify a corresponding terminal, an international mobile subscriber identity (IMSI), a temporary mobile subscriber identity (TMSI), a media access control (MAC) address of the machine-type communication terminal, a serial number of the machine-type communication terminal, and the like, may be used as the identifier.

Uplink radio resource allocation information may include information associated with a location of an uplink radio resource that the machine-type communication terminal uses to transmit data, information associated with a modulation scheme for data to be transmitted to an uplink, information associated with a coding level for the data to be transmitted to the uplink, and the like.

In an aspect of embodiments, when the uplink radio resource allocation information is allocation information for random access, the uplink radio resource allocation information may additionally include information associated with an uplink radio resource for the random access, information associated with an index of a random access preamble, and the like.

In another aspect of embodiments, the uplink radio resource allocation information is not allocation information for the random access, the uplink radio resource allocation information may additionally include a masking sequence for uplink transmission, a hopping sequence, a scheduling identifier, information associated cyclic delay diversity (CDD) transmission, and the like.

The EB information may be information indicating whether subsequent allocation information IE exists. In an aspect of embodiments, when the size of the allocation information IE is fixed and the information associated with the number of allocation information IEs does not included in the resource allocation configuration information 810, the EB information may not exist.

In another aspect of embodiments, when the size of the allocation information IE is fixed or the information associated with the size of the allocation information IE is included in the allocation information IE, whether subsequent allocation information IE exists may be determined based on the EB information. In this example, the scheduling message may not include the resource allocation configuration information 810.

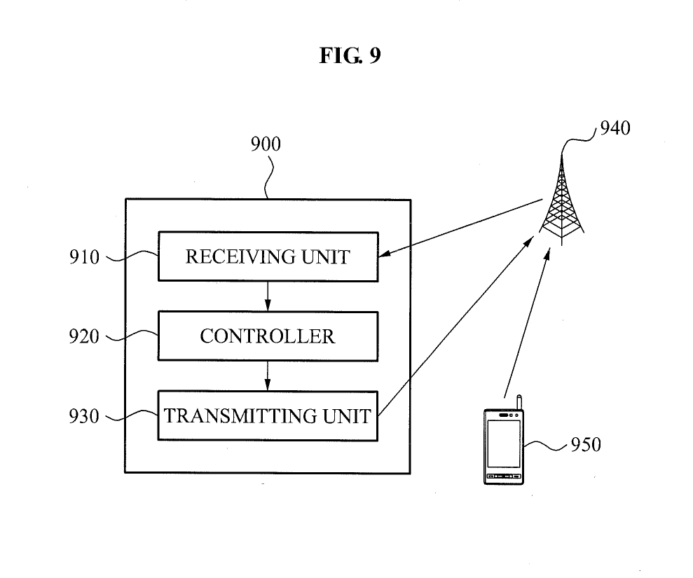

FIG. 9 illustrates a machine-type communication terminal 900 according to an embodiment of the present invention. The machine-type communication terminal 900 may include a receiving unit 910, a controller 920, and a transmitting unit 930.

In an aspect of embodiments, the receiving unit 910 may receive, from a machine-type communication base station 940, control information with respect to contention-based radio resources.

The controller 920 may identify the contention-based radio resources using the control information with respect to the contention-based radio resources.

The transmitting unit 930 may transmit, using the contention-based radio resources, data to the machine-type communication base station 940. In an aspect of embodiments, the transmitting unit 930 may transmit, to the machine-type communication base station 940, identifier of the machine-type communication terminal 900 along with the data. The machine-type communication base station 940 may determine, based on the identifier, a machine-type communication terminal that transmits the data among a plurality of machine type communication terminals, for example, among the machine-type communication terminal 900 and a second machine-type communication terminal 950.

In this example, at least one of a C-RNTI with respect to the machine-type communication terminal 900, an IMSI with respect to the machine-type communication terminal 900, a TMSI with respect to the machine-type communication terminal 900, an MAC address of the machine-type communication terminal 900, and a serial number of the machine-type communication terminal 900 may be used as the identifier of the machine-type communication terminal 900.

When the transmitting unit 930 transmits, using the contention-based radio resources, data to the machine-type communication base station 940, the data transmitted by the transmitting unit 930 may be collide with data transmitted by the second machine type communication terminal 950. In this example, the data transmission may fail.

When the data transmission succeeds, the receiving unit 910 may receive an ACK with respect to the data. When the data transmission fails, the receiving unit 910 may receive an NACK with respect to the data.

In another aspect of embodiments, the receiving unit 910 may receive, from the machine-type communication base station 940, control information with respect to shared allocation radio resources. The controller 920 may identify the shared allocation radio resources based on the control information with respect to the shared allocation radio resources. The machine-type communication terminal 900 may communicate with the second machine-type communication terminal 950 to determine a terminal that will transmit data to the machine-type communication base station 940 using a predetermined uplink radio resource. When the shared allocation radio resources are used, may only the machine-type communication terminal 900 use the predetermined radio resource. Therefore, the data transmission may have a high probability of being successfully performed.

When data transmission fails, the transmitting unit 930 may retransmit the data. In an aspect of embodiments, the receiving unit 910 may receive a plurality of contention-based radio resources at a time. In this example, the controller may identify the plurality of contention-based radio resources at a time, and the transmitting unit 930 may select at least one radio resource among the plurality of contention-based radio resources to transmit the data. When the data transmission fails, the transmitting unit 930 may select another radio resource among the identified contention-based radio resources, and may retransmit the data using the selected radio resource.

The transmitting unit 930 may successively transmit data using the radio resources allocated through single radio resource allocation and thus, a reliability of data transmission may be improved.

In an aspect of embodiments, when the data transmitted by the transmitting unit 930 is successfully transmitted, the machine-type communication base station 940 may transmit, to the machine-type communication terminal 900, an ACK with respect to the received data. The receiving unit 910 may receive the ACK with respect to the transmitted data, and the controller 920 may determine, based on the ACK, whether the data transmission is successfully performed.

When the transmitting unit 930 transmits the data using a first radio resource among the plurality of contention-based radio resources, and the receiving unit 910 receives an ACK with respect to the data, data transmission using a second radio resource and data transmission using a third radio resource after the data transmission using the first radio resource may not be performed, and the data transmission may be completed. The second radio resource and the third radio resource may not be used any longer and thus, the machine-type communication base station 940 may allocate the second radio resource and the third radio resource again, to receive other data.

In an aspect of embodiment, when the transmitting unit 930 transmits data using the first radio resource among the plurality of contention-based radio resources, and the receiving unit 910 does not receive an ACK with respect to the data, the transmitting unit 930 may select the second radio resource among the plurality of contention-based radio resources, and may retransmit the data using the second radio resource.

In an aspect of embodiments, the receiving unit 910 may receive paging information from the machine-type communication base station 940. In this example, the transmitting unit 930 may transmit data in response to the paging information. The machine-type communication base station 940 may transmit the paging information to receive the data from the machine-type communication terminal 900.

In another aspect of embodiments, the transmitting unit 930 may transmit a resource allocation request to the machine-type communication base station 940. The machine-type communication base station 940 may allocate radio resources to the machine-type communication terminal 900 in response to the resource allocation request. The machine-type communication base station 940 may allocate contention-based radio resources or shared allocation-based radio resources. The machine-type communication terminal 900 may actively request resource allocation to transmit data to an uplink.

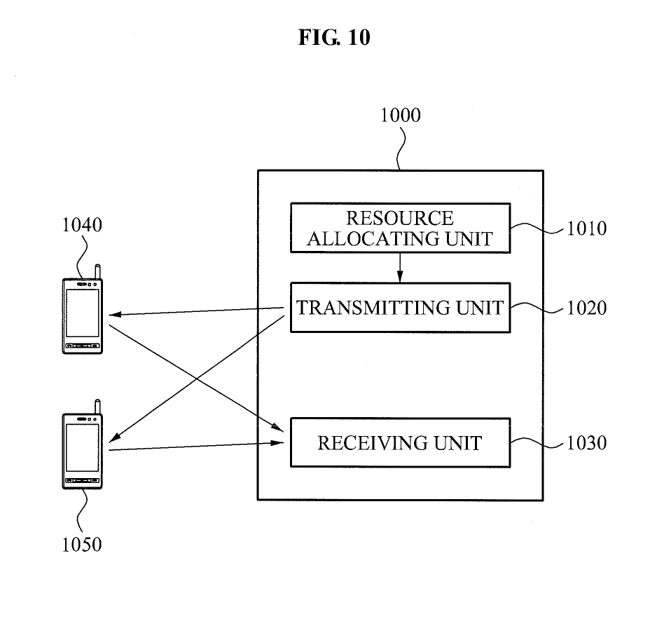

FIG. 10 illustrates a machine-type communication base station 1000 according to another embodiment of the present invention. The machine-type communication base station 1000 may include a resource allocating unit 1010, a transmitting unit 1020, and a receiving unit 1030.

The resource allocating unit 1010 may determine radio resources allocated to machine-type communication terminals 1040 and 1050 among radio resources allocated to the machine-type communication base station 1000. Radio resources allocated to the allocating unit 1010 may be radio resources to be used by the machine-type communication base station 1000. The resource allocating unit 1010 may allocate the determined radio resources as contention-based radio resources or shared allocation radio resources.

The transmitting unit 1020 may transmit control information with respect to the allocated radio resource to the machine-type communication terminals 1040 and 1050. The machine-type communication terminals 1040 and 1050 may be included in the same terminal group or may be included in different terminal groups.

The receiving unit 1030 may receive data from the machine-type communication terminals 1040 and the 1050 using the allocated radio resources.

In an aspect of embodiment, the machine-type communication terminals 1040 and 1050 may be included in the same terminal group. The resource allocating unit 1010 may allocate, to the terminal group including the machine-type communication terminal 1040 and 1050, the determined radio resources as the contention-based radio resources.

The machine type communication terminals 1040 and 1050 may perform data transmission based on the allocated radio resources, respectively. When the machine-type communication terminals 1040 and 1050 have data to transmit, both the terminals 1040 and 1050 may perform data transmission based on the same radio resource. In this example, the data may collide and thus, the receiving unit 1030 may not receive the data.

In another aspect of embodiments, the resource allocating unit 1010 may allocate, to the terminal group including the machine-type communication terminals 1040 and 1050, the determined radio resources as the shared allocation-based radio resources. The machine-type communication terminals 1040 and 1050 may communicate to perform data transmission using different radio resources from each other.

In an aspect of embodiments, the receiving unit 1030 may receive an identifier of the machine type communication terminal 1040, from the machine-type communication terminal 1040 that transmits the data. The receiving unit 1030 may identify, based on the received identifier, a machine-type communication terminal that transmits data.

In an aspect of embodiments, the resource allocating unit 1010 may allocate, to a terminal group, a plurality of radio resources at a time. The transmitting unit 1020 may transmit, to the machine type communication terminals 1040 and 1050, control information with respect to the plurality of allocated radio resources.

The receiving unit 1030 may receive data from each of the machine type communication terminals 1040 and 1050. When the data is successfully received, the transmitting unit 1020 may transmit an ACK with respect to the data to each of the machine-type communication terminals 1040 and 1050.

In an aspect of embodiments, the resource allocating unit 1010 may allocate a plurality of radio resources to a terminal group. The plurality of radio resources may include a first radio resource and a second radio resource. The second radio resource may be a subsequent radio resource of the first radio resource. The machine-type communication terminal 1040 may transmit data using the first radio resource.

When the receiving unit 1030 successfully receives the data using the first radio resource, the transmitting unit 1020 may transmit an ACK with respect to the received data to the machine-type communication terminal 1040. In this example, the receiving unit 1030 may not perform receiving of the data using the second radio resource, and may complete the data reception procedure.

Depending on embodiments, data transmission using the first radio resource may fail. In this example, the receiving unit 1030 may not receive data using the first radio resource. The transmitting unit 1020 may not transmit an ACK with respect to the data. The receiving unit 1030 may retransmit the data using the second radio resource.

Depending on embodiment, the transmitting unit 1020 may transmit paging information to the machine-type communication terminal 1040, and the receiving unit 1030 may receive data from the machine type communication terminal 1050 in response to the paging information. The machine type communication base station 100 may control, based on the paging information, the machine type communication terminal 1040 to transmit the data.

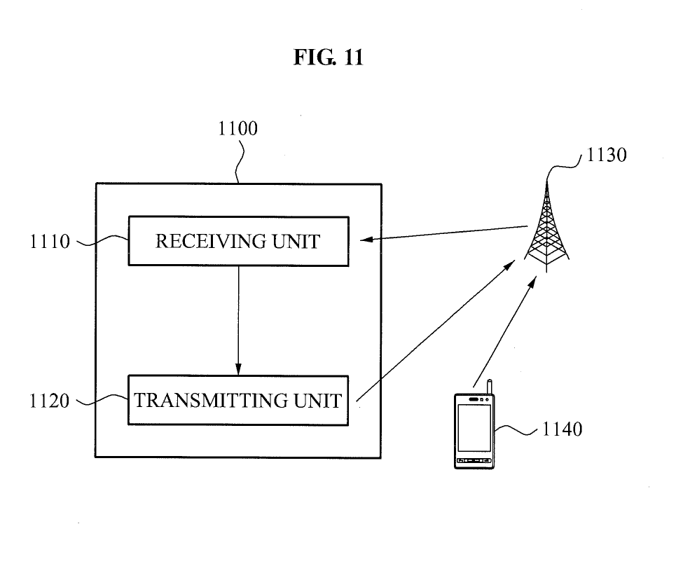

FIG. 11 illustrates a machine-type communication terminal 1100 according to another embodiment of the present invention. The machine-type communication terminal 1100 may include a receiving unit 1110 and a transmitting unit 1120.

The receiving unit 1110 may receive control information with respect to radio resources from the machine-type communication base station 1130. In an aspect of embodiments, the radio resources may include at least one of a frequency band and a time section allocated to the machine-type communication base station 1130.

In an aspect of embodiments, the machine-type communication base station 1130 and the machine type communication terminal 1110 may perform data transmission using a plurality of carrier components. In this example, contention-based radio resources may be allocated to several carrier components among the plurality of carrier components.

In an aspect of embodiments, the receiving unit 1110 may receive, using system information of a machine-type communication base station 1130, control information with respect to the radio resources.

In an aspect of embodiments, the radio resources may be allocated as contention-based radio resources or shared allocation radio resources. When the radio resources are allocated as the contention-based radio resources, a plurality of machine-type communication terminals may perform data transmission using the radio resources without communication. When the radio resources are allocated as the shared allocation radio resources, the plurality of machine-type communication terminals may perform data transmission after communication. According to the shared allocation scheme, a predetermined radio resource is determined, in advance, to be used by a predetermined machine-type communication terminal and thus, a reliability of data transmission may increase.

In an aspect of embodiments, the contention-based radio resources may include a control area for transmitting a pilot symbol or a preamble and a data area for transmitting data.

The transmitting unit 1120 may transmit, using the contention-based radio resources, data to the machine-type communication base station 1030. The transmitting unit 1120 may transmit the data using the data area included in the contention-based radio resources. In this example, the data included in the data area may be demodulated using the pilot symbol or the preamble included in the control area.

Operations of the machine-type communication terminal may be independently applied to resource allocation and data transmission, regardless of a connection state of a conventional mobile communication terminal, such as, an idle state and a connection state.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. An operating method of a machine-type communication base station, the method comprising:
receiving data from a machine-type communication terminal using contention-based radio resources; and
transmitting, to the machine-type communication terminal, an identifier of the machine-type communication terminal using one of the contention-based radio resources and shared allocation radio resources, when the data is received.

2. The method of claim 2, wherein the transmitting comprises:
determining whether the received data has an error; and
transmitting one of an acknowledgement (ACK) and a negative acknowledgement (NACK) based on a result of the determining.

3. An operating method of a machine-type communication base station, the method comprising:
allocating contention-based radio resources and shared allocation radio resources to a machine-type communication terminal; and
receiving data from the machine-type communication terminal to which the contention-based radio resources and the shared allocation radio resources are allocated,
wherein the allocating comprises successively allocating the shared allocation radio resources, or discretely allocating a plurality of radio resources over multiple subframes.

4. The method of claim 3, wherein, when the plurality of radio resources is discretely allocated over the multiple subframes, the receiving comprises repeatedly receiving the same data from the machine-type communication terminal using the plurality of radio resources.
